(19) United States
(12) Patent Application Publication
(10) Pub. No.: US 2026/0100172 A1
(43) Pub. Date: Apr. 9, 2026

(54) VEHICLE CAMERA-BASED AMBIENT LIGHT DETECTION

(71) Applicant: FCA US LLC, Auburn Hills, MI (US)

(72) Inventors: Daniel P Cashen, Auburn Hills, MI (US); Emily A Robb, Auburn Hills, MI (US); Esaias Pech, Auburn Hills, MI (US)

(21) Appl. No.: 18/910,683

(22) Filed: Oct. 9, 2024

(51) Int. Cl. G09G 5/10; B60R 1/22; G06T 7/00; H04N 23/71; H04N 23/73

(52) U.S. Cl. CPC G09G 5/10; G06T 7/97; H04N 23/71; H04N 23/73; B60R 1/22; B60R 2300/105; B60R 2300/806; G06T 2207/30252; G09G 2320/0626; G09G 2380/10

(57) ABSTRACT

A method of detecting ambient light outside of a vehicle includes capturing a first image with a sensor of a camera mounted on the vehicle, generating image data that is representative of the light incident on the sensor at the time the first image was captured, analyzing the image data to determine an ambient light level, and controlling at least one vehicle light as a function of the determined ambient light level.

### FIELD

The present disclosure relates to ambient light detection for a vehicle that utilizes one or more vehicle cameras.

### BACKGROUND

Some vehicles include a light sensor at a single location in the vehicle that function like a switch. The light sensor uses a single threshold for light, and is in one state (e.g. off) when detected light is below the threshold and is in a second state (e.g. on) when the detected light is above the threshold. The light sensor is used to control headlights of the vehicle to turn the headlights on when the detected light is below the threshold. The light sensor detects light only at the single location of the sensor and is not sensitive or responsive to a direction of light or location of the sun or other ambient light source.

### SUMMARY

In at least some implementations, a method of detecting ambient light outside of a vehicle includes capturing a first image with a sensor of a camera mounted on the vehicle, generating image data that is representative of the light incident on the sensor at the time the first image was captured, analyzing the image data to determine an ambient light level, and controlling at least one vehicle light as a function of the determined ambient light level.

In at least some implementations, the vehicle light is part of an output of a display within the vehicle and the step of controlling the light includes one or both of increasing the luminance of the display when the determined ambient light is above a threshold, and decreasing the luminance of the display when the determined ambient light is below the threshold.

In at least some implementations, the vehicle light is part of an output of a display within the vehicle and the step of controlling the light includes changing the luminance of the display as a function of the determined ambient light.

In at least some implementations, the vehicle light is an external light viewable from an area outside of the vehicle, and wherein the vehicle light is controlled to be on when the determined ambient light is below the threshold.

In at least some implementations, the camera is a forward-facing camera and an output of the camera is used by a parking assist feature of the vehicle.

In at least some implementations, the camera is mounted above a hood of the vehicle. In at least some implementations, at least part of a field of view of the camera includes at least part of the hood, and the at least part of the field of view is used to determine the ambient light level.

In at least some implementations, the method includes capturing a second image and generating image data for the second image that is representative of the light incident on the sensor at the time the second image was captured, and comparing the image data of the first image with the image data of the second image to determine a change in ambient light level.

In at least some implementations, the sensor includes an array of pixels having a sensitivity to light and at least one exposure setting determines an amount of time over which the first image is captured, and the ambient light level is determined as a function of the at least one exposure setting. In at least some implementations, the at least one exposure setting is adjusted as a function of the image date of the first image, and wherein the ambient light is determined as a function of the adjustment of the at least one exposure setting.

In at least some implementations, the method also includes capturing a second image with a second camera mounted to the vehicle, generating image data that is representative of the light incident on the sensor at the time the second image was captured, analyzing the image data of the second image to determine a second ambient light level, and controlling at least one vehicle light as a function of the determined first ambient light level and the determined second ambient light level. In at least some implementations, the first camera is a front-facing camera and the second camera is a rear-facing camera or a side-facing camera.

In at least some implementations, the step of analyzing the image data to determine an ambient light level uses raw image data.

In at least some implementations, a system for a vehicle, includes a camera mounted on the vehicle and having a sensor responsive to light at the sensor, and a control system communicated with the sensor. The control system includes one or more processors, memory and programming arranged to capture a first image with the sensor of the camera, generate image data that is representative of the light incident on the sensor at the time the first image was captured, analyze the image data to determine an ambient light level, and control at least one vehicle light as a function of the determined ambient light level.

In at least some implementations, the camera has at least one exposure setting that is adjustable and the exposure setting when the first image is captured is used to determine the ambient light level.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a top view of a vehicle;

FIG. 2 is a side view of the vehicle;

FIG. 3 is a view of part of an interior of a vehicle;

FIG. 4 is a schematic view of a control system of the vehicle; and

FIG. 5 is a flowchart of a method of determining ambient light level.

### DETAILED DESCRIPTION

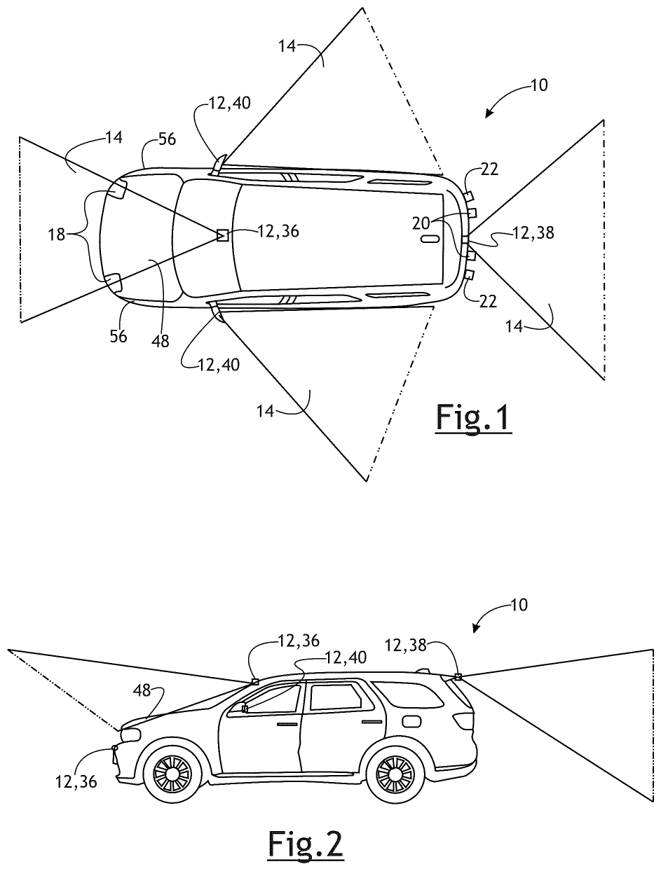

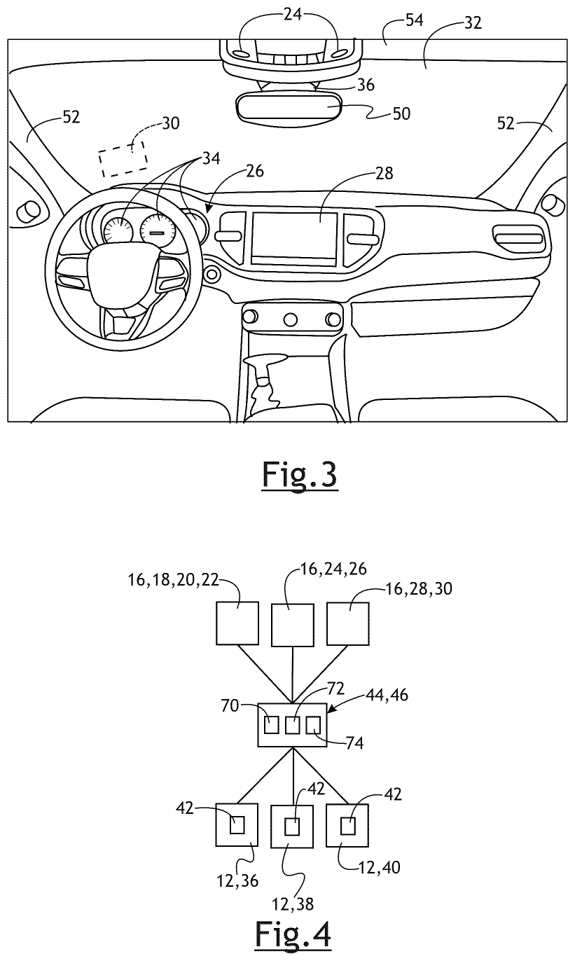

Referring in more detail to the drawings, FIG. 1 illustrates a vehicle 10 having one or more cameras 12 each arranged to capture images including all or part of a field of view 14 of each camera 12. The vehicle 10 also includes multiple light sources 16, which may be on the exterior of the vehicle 10 or within an interior of the vehicle 10. The light sources 16 include, by way of non-limiting examples, headlights 18, taillights 20, brake lights 22, and as shown in FIG. 3, interior lights like overhead lights 24, dashboard lights 26 and displays like an infotainment system screen 28 and a heads-up-display (HUD) 30. For example, the light output levels (e.g. luminance or brightness) of a HUD 30 that is provided on or near a windshield 32 can be adjusted, as can the luminance of at least some interior lights which might be LED lights, infotainment displays 28, illuminated gauges 34, and other lights. Often, when it is darker outside, less luminance is needed from interior light sources 16 for viewing displays 28, 30, gauges 34 and other things within the vehicle interior. Conversely, when it is lighter outside, greater luminance may be needed to properly view various things within the vehicle interior.

One or more of the vehicle cameras 12 may be exterior cameras 12 mounted facing outwardly from the vehicle 10 and including fields of view 14 that include part of the environment outside of the vehicle 10 and optionally, part of the vehicle 10. Such cameras 12 may be mounted about the exterior of the vehicle 10, such as a forward-facing camera 36, a rear-facing camera 38 and one or more side cameras 40 that may be positioned on or adjacent to a side of the vehicle 10. By way of non-limiting examples: the forward-facing camera 36 may capture images of the environment in front of the vehicle 10 (as illustrated by its field of view 14 in FIGS. 1 and 2) and may be useful during parking the vehicle 10 to facilitate navigation relative to obstacles in front of the vehicle 10; the rear-facing camera 38 may capture images of the environment behind the vehicle 10 (as illustrated by its field of view 14 in FIGS. 1 and 2) and may be useful during reverse vehicle 10 operation; and the side cameras 40 may capture images of the environment to the sides of the vehicle 10 (as illustrated by their fields of view 14 in FIG. 1) and may be useful to provide views of vehicle 10 blind spots behind a driver, and to provide part of a surround or 360-degree view around the vehicle 10.

As shown in FIG. 4, the cameras 12 may each have an image sensor 42 that captures or is otherwise responsive to light that enters the camera 12 through an aperture (which may include a lens) and is incident upon the sensor 42. The sensor 42 includes separate zones or pixels, and light on a pixel results in pixel data (e.g. one or more numbers) that is assigned as a function of the color and intensity or luminance of the light incident on the pixel. One or more exposure settings may be adjusted to capture images as desired, such as but not limited to, the duration at which light is incident on the image sensor 42 for an image and the sensitivity of the sensor 42 to light (e.g. ISO sensitivity). An image sensor 42 may be used to capture images (record pixel data) at defined intervals, and the pixel data is determined for each pixel in each image, and all pixel data in a particular image may be called image data. A series of images can be used to provide a video feed from the camera(s) 12, at a desired frame rate which typically is a number of images captured per second. Representative types of image sensors are Charge-Coupled Devices (CCD) or Complementary Metal-Oxide-Semiconductors (CMOS sensors). One or more cameras 12 may capture visible light, that is, light that can be perceived or is visible to the human eye.

In addition to the image sensor 42, each camera may have or be associated with an image processor 44 or controller that collects image data from the image sensor 42. The image processor 44 may perform one or more processes on the image data. Image data captured by the sensor 42 and before one or more processes are performed may be called raw image data, and after processing, may be called processed image data. The processing of the raw image data may be done for different reasons. For example, the images may be cropped to delete areas of the image that are not needed for a particular purpose, and/or the image file size may be compressed for systems or uses that do not require higher resolution images. Filters may be used to increase or decrease digital “noise” in an image, sharpen or blur/dull an image, enhance or diminish colors (e.g. saturation adjustment), perform a color or “white balance” adjustment, convert to a different color profile, and the like.

During image processing, the light intensity or luminance may be adjusted in one or more pixels where, for example, the luminance is outside of one or more thresholds which may either reduce or increase the luminance in pixels. The luminance adjustment may be made for each pixel in an image, for example to reduce the luminance in an image that is too bright on average (or as desired based upon an analysis of a histogram or other collection of relevant data), or to increase the luminance in an image that is not bright enough, as determined by suitable programming of the image processor 44 or control system 46 (of which an image processor 44 may be a part). Further, the image processor 44/control system 46 may automatically adjust one or more exposure settings to control the light captured by the image sensor 42 for one or more subsequent images.

As shown in FIGS. 1 and 2, a forward-facing camera 36 may be mounted above part of a vehicle 10, such as a vehicle hood 48. In an example, the camera 12 is mounted behind a rear-view mirror 50 (FIG. 3) within the interior of the vehicle 10. The camera 12 may receive light through the windshield 32 of the vehicle 10 and the field of view 14 of the camera 12 may include therein a reference surface, which may be a surface of the vehicle 10. In the example of the camera 12, 36, the reference surface is all or part of the vehicle hood 48. The vehicle hood 48, or part thereof that is within the camera field of view 14, may have a known or predetermined reflectivity, for example, and so luminance within the portion of images including the hood 48 may be used to estimate or determine the brightness or intensity of light on the hood 48 and thus, the ambient light level. Other vehicle 10 surfaces (FIG. 3), such as pillars 52 (A, B or C, including trim pieces thereon, or part of the vehicle headliner 54 or part of the windshield 32), or part of a vehicle side panel 56 (FIG. 1) adjacent to the hood 48, may be used in addition to or instead of the hood 48, as desired.

As the vehicle 10 moves, the portion of the camera field of view 14 that does not include part of the vehicle 10 will include different elements, such as different road surfaces, trees, the sky, obstacles, people and other things that have different reflectivity. It can be more difficult to estimate the ambient light level or intensity based upon areas of the images that change when the vehicle 10 moves, so part of the vehicle 10 within the field of view 14 provides a consistent reference surface by which light level changes can be used to estimate or determine ambient light level.

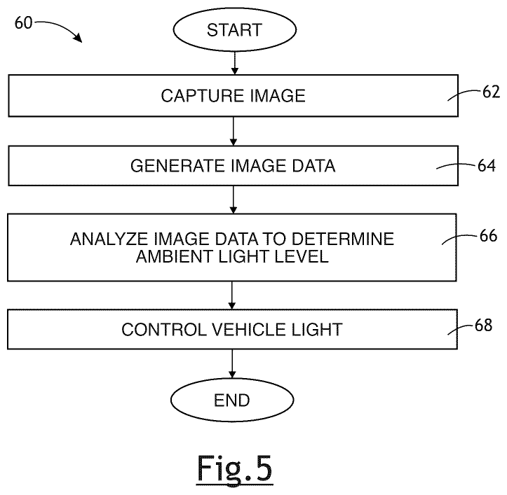

In view of this, a vehicle camera 12 can be used to detect ambient light, that is, light outside of the vehicle 10, and estimate or determine an intensity or level of the ambient light. In at least some implementations of a method 60 of detecting ambient light outside of a vehicle 10, as shown in FIG. 5, in step 62 a first image is captured by a camera 12 mounted on the vehicle 10, and in step 64 image data is generated that is representative of the light incident on the camera sensor 42 at the time the first image was captured. Next, in step 66, the image data is analyzed to determine an ambient light level.

The ambient level determination can then be used in step 68 to control at least one vehicle light. For example, external lights, like vehicle headlights 18 and taillights 22, can be turned on automatically when the ambient light level is below a threshold. Additionally or instead, the at least one vehicle light being controlled can be part of an output of a display 28 within the vehicle 10. In this example, controlling the light may include one or both of increasing the luminance of the display 28 when the determined ambient light is above a threshold, and decreasing the luminance of the display 28 when the determined ambient light is below the threshold. Further, the system may use more than one threshold, and the luminance of an interior light, such as the output of a display 28, 30, may be adjusted in many steps or levels and need not simply be an on-off or two setting adjustment. In this regard, the output may be adjusted as a function of the determined ambient light, over any desired range of output and ambient light. Further, a window with adjustable tint could have the tint adjusted as a function of the determined ambient light, shades could be deployed or retracted to block at least some direct sunlight from entering the vehicle at the height of a driver's eyes, for example.

In at least some implementations, the camera 12 is a forward-facing camera 36 and an output of the camera 12 is used for a purpose in addition to ambient light level determination, such as a parking assist feature of the vehicle 10 or to support autonomous or semi-autonomous vehicle driving. As noted herein, in at least some implementations, the camera 12 is mounted above a hood 48 of the vehicle 10 and at least part of the hood 48 is within the field of view 14 of the camera 12, and at least that part of the camera field of view 14 (e.g. the corresponding portion of the camera 12 images) is used to determine the ambient light level.

The method may also include capturing a second image and generating image data for the second image that is representative of the light incident on the camera sensor 42 at the time the second image was captured. The image data of the first image can then be compared with the image data of the second image to determine a change in ambient light level. Any desired time interval may be used between the first image and the second image, and multiple additional images may be used, taken over some period of time, to determine an average ambient light level over that time period, or a change in ambient light level.

As noted above, the camera 12 may have one or more adjustable parameters or exposure parameters that may be adjusted to control the exposure of images taken by the camera 12. The one or more exposure settings may correlate to the ambient light level and thus, the one or more exposure settings may be used to determine a relative ambient light level. For example, higher ambient light conditions may require an exposure duration that is shorter than lower ambient light levels, and/or a sensor ISO sensitivity or other exposure parameter that is different. Thus, one or a combination of more than one exposure parameter or exposure setting may be used to determine the ambient light level. In at least some implementations, the exposure parameter(s) or setting(s) may be adjusted as a function of the image data of the first image, and the ambient light may be determined as a function of the adjustment or determination of the at least one exposure setting.

In at least some implementations, the method may include capturing a second image with a second camera 12 mounted to the vehicle 10, generating image data that is representative of the light incident on the sensor 42 at the time the second image was captured, analyzing the image data of the second image to determine a second ambient light level, and controlling at least one vehicle light as a function of the determined first ambient light level and the determined second ambient light level.

In at least some implementations, the first camera 12 is a forward-facing camera 36 and the second camera 12 is a rear-facing camera 38 or a side camera 40. In one example, direct sunlight may be incident on the second camera 12 but not the first, such as when the sun is lower in the sky and located behind or off to the side of the vehicle, and this may give different ambient light level determinations from image data of different cameras 12. From the difference, or an analysis of image data from multiple cameras 12, the ambient light level may be more accurately determined. Further, the light level may be determined spatially, with reference to where the ambient level is greater or lesser, and interior or exterior lights can be controlled accordingly. In other words, the location of the ambient light source (e.g. the sun) and the angle of light rays on the vehicle can be determined. For example, if the determine light level is greater at a forward-facing camera 36 than at a rear-facing camera 38, it can be determined that the source of ambient light is more directed at the front than the rear of the vehicle 10. The output of interior light sources 16 viewed by an occupant looking toward the front of the vehicle 10 may be increased to counter the brighter light at the front of the vehicle 10.

Additional spatial control of lights is also possible by use of the camera 12-based ambient light determination systems and method. For example, in higher ambient light levels a vehicle HUD light intensity is increased so that the information on the HUD 30 can be seen. However, when the vehicle 10 is facing a darker area, like a tunnel or a dark garage, but the vehicle is in higher ambient light conditions, the HUD output level may remain high to counteract the higher ambient light conditions. However, the high intensity HUD output level may appear too bright against the darker background in the area of the HUD 30. To avoid this, the image data can be analyzed with regard to the area of the image that is in front of the HUD 30, and when that area is darker, the HUD light output level can be decreased even when the general or overall ambient light level in the area of the vehicle 10 is higher.

Accordingly, one or more cameras may be used to provide data from which ambient light levels can be determined. The ambient light levels may be for the environment outside of and in the area of the vehicle 10 as a whole, or specific to different areas of the vehicle, or responsive to the location and direction of the sun or other ambient light source. Various vehicle lights can be controlled as a function of the ambient light determination(s) and the control can be greatly improved over prior, single light sensors in vehicles that included a single threshold for light, and were in one state when detected light was below the threshold and were in a second state when the detected light was above the threshold.

To perform the functions and desired processing set forth herein, as well as the computations therefore, the control system may include, but is not limited to, one or more controller(s), control unit(s), processor(s), computer(s), DSP(s), collectively referred to by reference number 70 in FIG. 4, memory 72, storage, register(s), timing, interrupt(s), communication interface(s), and input/output signal interfaces, and the like, as well as combinations comprising at least one of the foregoing. For example, the control system may include input signal processing and filtering to enable accurate sampling and conversion or acquisitions of such signals from the cameras 12 and sensors 42. As used herein the terms control system may refer to one or more processing circuits such as an application specific integrated circuit (ASIC), an electronic circuit, a processor (shared, dedicated, or group) and memory that executes one or more software or firmware programs 74, a combinational logic circuit, and/or other suitable components that provide the described functionality.

The control system that analyzes the image data and determines the ambient light level as noted herein, may be part of a vehicle 10 control system or a separate controller or control system associated with one or more cameras 12. The control system may be distributed among different vehicle 10 modules, such as an infotainment system control module, engine control module or unit, powertrain control module, transmission control module, and the like, if desired, and the memory, programming and one or more processors may be one or both integrated into the vehicle 10 or remotely located and wirelessly communicated to the vehicle 10, as desired.

The term “memory” or “storage” 72 as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions 74 executable by a processor 70 or controller or the like to enable control or allocate resources of a computing device.

1. A method of detecting ambient light outside of a vehicle, comprising:
capturing a first image with a sensor of a camera mounted on the vehicle;
generating image data that is representative of the light incident on the sensor at the time the first image was captured;
analyzing the image data to determine an ambient light level; and
controlling at least one vehicle light as a function of the determined ambient light level, wherein at least part of a field of view of the camera includes a surface of the vehicle, and the at least part of the field of view of the camera that includes the surface is used to determine the ambient light level based at least in part on a known reflectivity of the surface.

2. The method of claim 1 wherein the vehicle light is part of an output of a display within the vehicle and the step of controlling the light includes one or both of increasing the luminance of the display when the determined ambient light is above a threshold, and decreasing the luminance of the display when the determined ambient light is below the threshold.

3. The method of claim 1 wherein the vehicle light is part of an output of a display within the vehicle and the step of controlling the light includes changing the luminance of the display as a function of the determined ambient light.

4. The method of claim 1 wherein the vehicle light is an external light viewable from an area outside of the vehicle, and wherein the vehicle light is controlled to be on when the determined ambient light is below the threshold.

5. The method of claim 1 wherein the camera is a forward-facing camera and an output of the camera is used by a parking assist feature of the vehicle.

6. The method of claim 1 wherein the camera is mounted above a hood of the vehicle.

7. The method of claim 6 wherein the surface is defined by at least part of the hood.

8. The method of claim 1 which includes capturing a second image and generating image data for the second image that is representative of the light incident on the sensor at the time the second image was captured, and comparing the image data of the first image with the image data of the second image to determine a change in ambient light level.

9. The method of claim 1 wherein the sensor includes an array of pixels having a sensitivity to light and wherein at least one exposure setting determines an amount of time over which the first image is captured, and the ambient light level is determined as a function of the at least one exposure setting.

10. The method of claim 9 wherein the at least one exposure setting is adjusted as a function of the image date of the first image, and wherein the ambient light is determined as a function of the adjustment of the at least one exposure setting.

11. The method of claim 1 which also includes:
capturing a second image with a second camera mounted to the vehicle;
generating image data that is representative of the light incident on the sensor at the time the second image was captured;
analyzing the image data of the second image to determine a second ambient light level, and wherein the step of controlling at least one vehicle light is accomplished as a function of the determined first ambient light level and the determined second ambient light level.

12. The method of claim 11 wherein the first camera is a front-facing camera and the second camera is a rear-facing camera or a side-facing camera.

13. The method of claim 1 wherein the step of analyzing the image data to determine an ambient light level uses raw image data.

14. A system for a vehicle, comprising:
a camera mounted on the vehicle and having a sensor responsive to light at the sensor;
a control system communicated with the sensor, wherein the control system includes one or more processors, memory and programming arranged to capture a first image with the sensor of the camera, generate image data that is representative of the light incident on the sensor at the time the first image was captured, analyze the image data to determine an ambient light level, and control at least one vehicle light as a function of the determined ambient light level, wherein the camera has a field of view that includes a portion of the vehicle, and at least part of a field of view of the camera that includes the portion of the vehicle is used to determine the ambient light level based at least in part on a known reflectivity of the portion of the vehicle.

15. The system of claim 14 wherein the vehicle light is part of an output of a display within the vehicle and the step of controlling the light includes one or both of increasing the luminance of the display when the determined ambient light is above a threshold, and decreasing the luminance of the display when the determined ambient light is below the threshold.

16. The system of claim 14 wherein the vehicle light is an external light viewable from an area outside of the vehicle, and wherein the vehicle light is controlled to be on when the determined ambient light is below the threshold.

17. (canceled)

18. (canceled)

19. The system of claim 14 wherein the camera has at least one exposure setting that is adjustable and the exposure setting when the first image is captured is used to determine the ambient light level.

20. The method of claim 11 wherein the second camera has a field of view that does not include the surface of the vehicle.

21. The system of claim 14 wherein the camera is a first camera, and a second camera is mounted on the vehicle and has a different field of view than the field of view of the first camera, and the control system is further arranged to capture a second image with the second camera mounted to the vehicle, generate image data that is representative of the light incident on a sensor of the second camera at the time the second image was captured, analyze the image data of the second image to determine a second ambient light level, and control at least one vehicle light as a function of the determined first ambient light level and the determined second ambient light level.

22. The system of claim 21 wherein the field of view of the second camera does not include the part of the vehicle that is in the field of view of the first camera.
